(19) United States
(12) Patent Application Publication
(10) Pub. No.: US 2012/0281980 A1
(43) Pub. Date: Nov. 8, 2012

(54) OPTICAL SENSOR NETWORKS AND METHODS FOR FABRICATING THE SAME

(76) Inventors: Hans S. Cho, Palo Alto, CA (US); Alexandre M. Bratkovski, Mountain View, CA (US); R. Stanley Williams, Portola Valley, CA (US); Peter George Hartwell, Sunnyvale, CA (US)

(21) Appl. No.: 13/384,943

(22) PCT Filed: Jan. 29, 2010
(86) PCT No.: PCT/US2010/022640

§ 371 Date: Jan. 19, 2012

(51) Int. Cl. H04B 10/08

(52) U.S. Cl. 398/28

(57) ABSTRACT

Various embodiments of the present invention are directed to sensor networks and to methods for fabricating sensor networks. In one aspect, a sensor network includes a processing node (110, 310), and one or more sensor lines (102,202,302) optically coupled to the processing node. Each sensor line comprises a waveguide (116,216,316), and one or more sensor nodes (112,210). Each sensor node is optically coupled to the waveguide and configured to measure one or more physical conditions and, encode measurement results in one or more wavelengths of light carried by the waveguide to the processing node.

### TECHNICAL FIELD

Embodiments of the present invention relate to sensor networks.

### BACKGROUND

A typical sensor network is composed of spatially distributed autonomous sensor nodes that each measure physical and/or environmental conditions, such as temperature, sound, vibration, pressure, motion, or pollutants, and relay the measurement results to a central processing or data storage node. Sensor networks are used to monitor conditions in a wide variety of industrial and environmental settings and have traditionally been implemented using either electrical wires or wireless transmission for relaying the measurement results. With wired sensor networks, each wire electronically connects one or more sensor nodes to the central processing node. Each wired sensor node includes, in addition to sensors and a microcontroller, an energy source such as a battery. With wireless sensor networks, each sensor node can communicate with the central processing node using a separate radio frequency. Each wireless sensor node includes, in addition to sensors, a radio transceiver or other wireless communication devices, a microcontroller, and an energy source.

Implementing either a wired or a wireless sensor network can be time consuming and inconvenient, because the equipment can be bulky and cost prohibitive and because the components are separately manufactured, often sold piece-by-piece, and have to be assembled. Consumers and users of sensing equipment continue to seek enhancements in sensor network technology in order to reduce costs, size, and time needed to assemble and implement sensor networks in a wide variety of settings.

### BRIEF DESCRIPTION OF THE DRAWINGS

FIG. 1 shows a schematic representation of a first example optical sensor network configured in accordance with one or more embodiments of the present invention.

FIG. 2 shows a schematic representation of a second example optical sensor network configured in accordance with one or more embodiments of the present invention.

FIG. 3 shows a schematic representation of a third example optical sensor network configured in accordance with one or more embodiments of the present invention.

FIG. 4A shows a schematic representation of a multiplexer/processing node configured in accordance with one or more embodiments of the present invention.

FIG. 4B shows a schematic representation of a multiplexer/demultiplexer processing node configured in accordance with one or more embodiments of the present invention.

FIG. 5 shows an isometric view of a first partially rolled-up sensor line configured in accordance with one or more embodiments of the present invention.

FIGS. 6A-6C show to plan views of three different ways in which a sensor node can be operated to encode measurement results in accordance with one or more embodiments of the present invention.

FIGS. 7A-7C show top plan views of three different ways in which a sensor node can be operated to encode measurement results in locally generated wavelengths in accordance with one or more embodiments of the present invention.

FIG. 8 shows an isometric view of a second partially rolled-up sensor line configured in accordance with one or more embodiments of the present invention.

FIG. 9 shows an isometric view of a third partially rolled-up sensor line configured in accordance with one or more embodiments of the present invention.

FIGS. 10A-10C show top plan views, of three different ways in which a sensor node can be operated to encode measurement results in accordance with one or more embodiments of the present invention.

FIGS. 11A-11C show top plan views of three different ways in which a sensor node can be operated to encode measurement results in accordance with one or more embodiments of the present invention.

FIG. 12A shows an isometric view and enlargement of a microring resonator and a portion of an adjacent waveguide in accordance with one or more embodiments of the present invention.

FIG. 12B shows a cross-sectional view of doped regions surrounding the microring; along a ling A-A, shown in FIG. 12A in accordance with one or more embodiments of the present invention.

FIG. 13 shows an isometric view of an example sensor node component operated in accordance with one or more embodiments of the present invention.

FIG. 14 shows a roll-to-roll process roe imprinting sensor nodes of a sensor line in accordance with one or more embodiments of the present invention.

### DETAILED DESCRIPTION

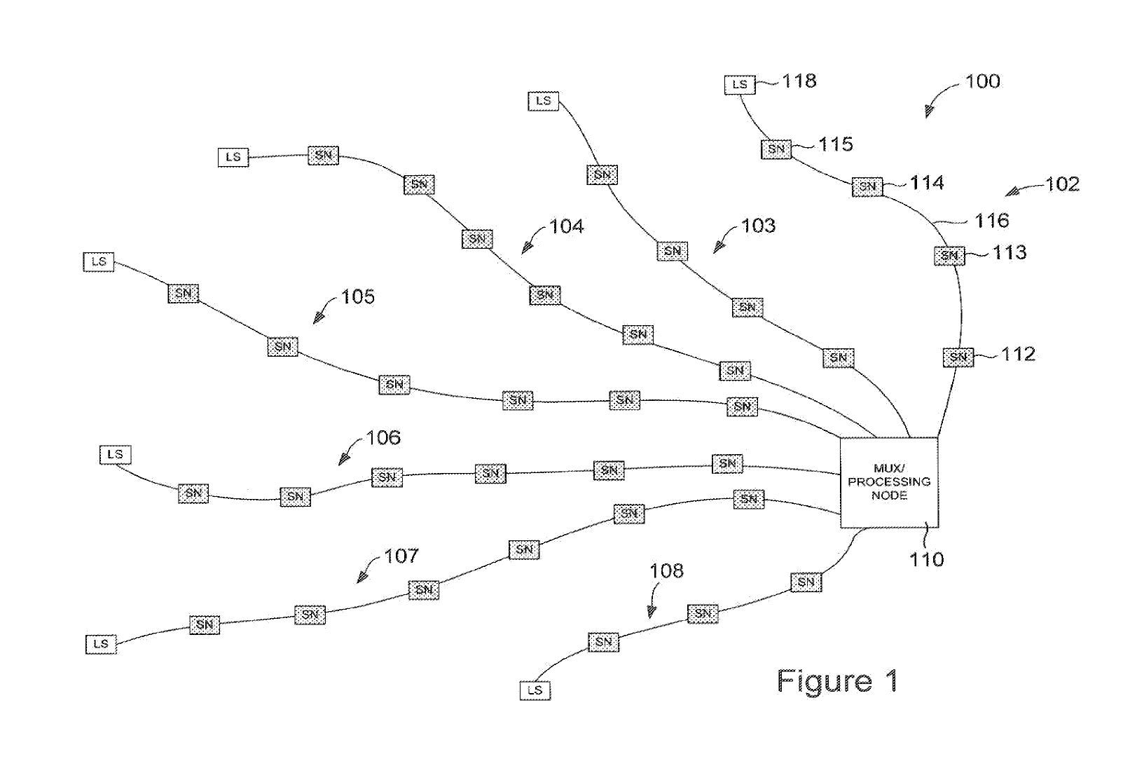

Various embodiments of the present invention are directed to sensor networks and to methods for fabricating sensor networks. FIG. 1 shows a schematic representation of an example optical sensor network 100 configured in accordance with one or more embodiments of the present invention. The sensor network 100 includes seven sensor lines 102-108 optically coupled to a multiplexer/processing node 110. Each sensor line includes a number of sensor nodes, SN, distributed along waveguide. For example, sensor line 102 includes four sensor nodes 112-115 optically coupled to a waveguide 116. Each sensor node of the sensor network 100 is configured to independently measure one or more physical or environmental conditions, or detect a change in conditions, at the sensor node's location, encode the measurement results in one or more wavelengths of light that are sent along a corresponding waveguide to the multiplexer/processing node 110, the conditions can be any combination of temperature, sound, vibration, pressure, motion, various pollutants or any other physical or environmental conditions.

As shown in the example of FIG. 1, each sensor line waveguide terminates with a light source, LS. The light sources can be light-emitting diodes (“LEDs”), single mode lasers, or multimode, lasers. Each light source is configured to inject one or more wavelengths of light into an optically coupled waveguide. Each sensor node located along a sensor hue encodes measurements in one or more of the wavelengths. For example, in certain embodiments, light source 118 can be configured to inject a single wavelength of light into the waveguide 116. Each sensor node 112-115 takes a turn encoding measurement results on the wavelength in one of tour time slots of approximately equal duration and in circular order. In other embodiments, each sensor node can encode a header followed by encoding a block of measurement results in a wavelength of light. The header can be used to identify the sensor nodes and can be used by downstream sensor nodes to indicate that the following block is not available for encoding measurement results and wait for the block to pass. For example, sensor node 115 encodes measurement results preceded by a header in the wavelength transmitted along the waveguide 116. Sensor node 114 detects the header and waits or a period of time enabling the block of measurement results to pass before it encodes a header followed by its own measurement results. In other embodiments, each light source can be configured to inject multiple wavelengths of light into the sensor line waveguide using wavelength division multiplexing. Each sensor node encodes measurement results in a different subset of the multiple wavelengths that are transmitted to the multiplexer/processing node 110, enabling the sensor nodes to encode and send measurement results simultaneously to the multiplexer/processing node 110. For example, each of the sensor nodes 112-115 can separately encode measurement results in different sets of wavelengths output from the light source 11S.

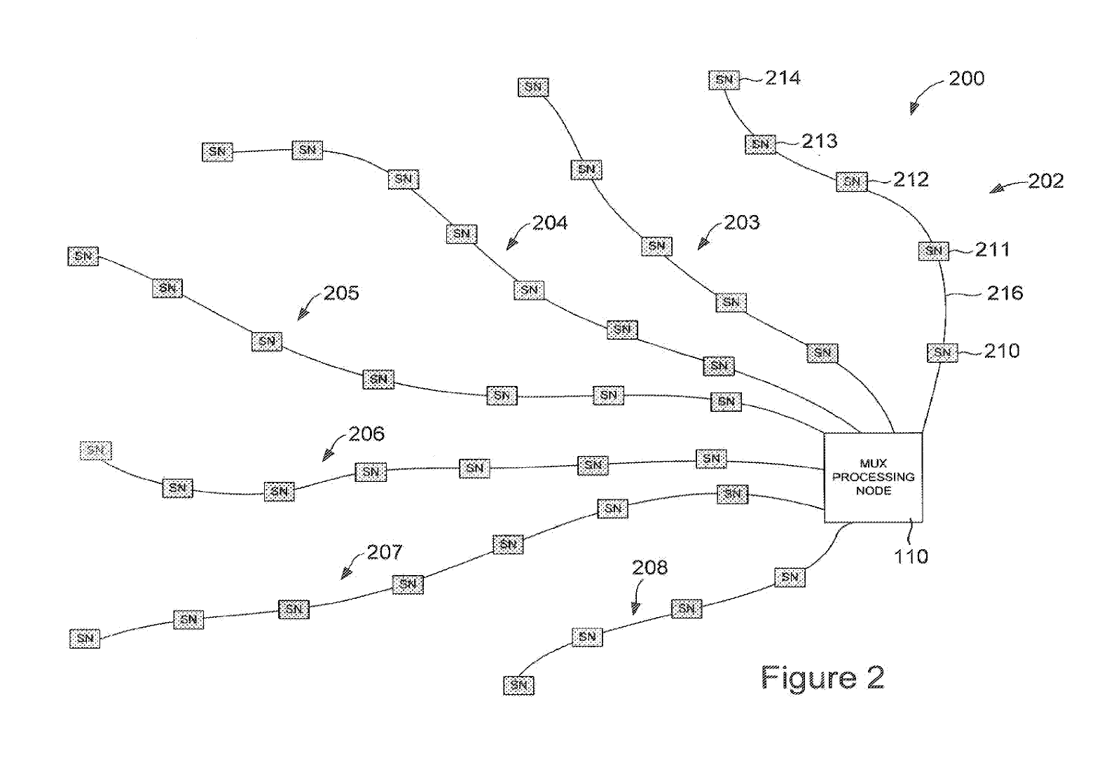

FIG. 2 shows a schematic representation of an example optical sensor network 200 configured in accordance with one or more embodiments of the present invention. The sensor network 200 includes seven sensor lines 202-208 optically coupled to a multiplexer/processing node 210 and is similar to the network 100 except light sources are not located as the end of the sensor line waveguides. Instead, each sensor node can be configured to include its own hot source for encoding measurement results. For example, in certain embodiments, sensor nodes 210-214 can each be configured with a separate light source for encoding measurement results in one or more wavelengths that are transmitted along a waveguide 216 to the multiplexer/processing node 210.

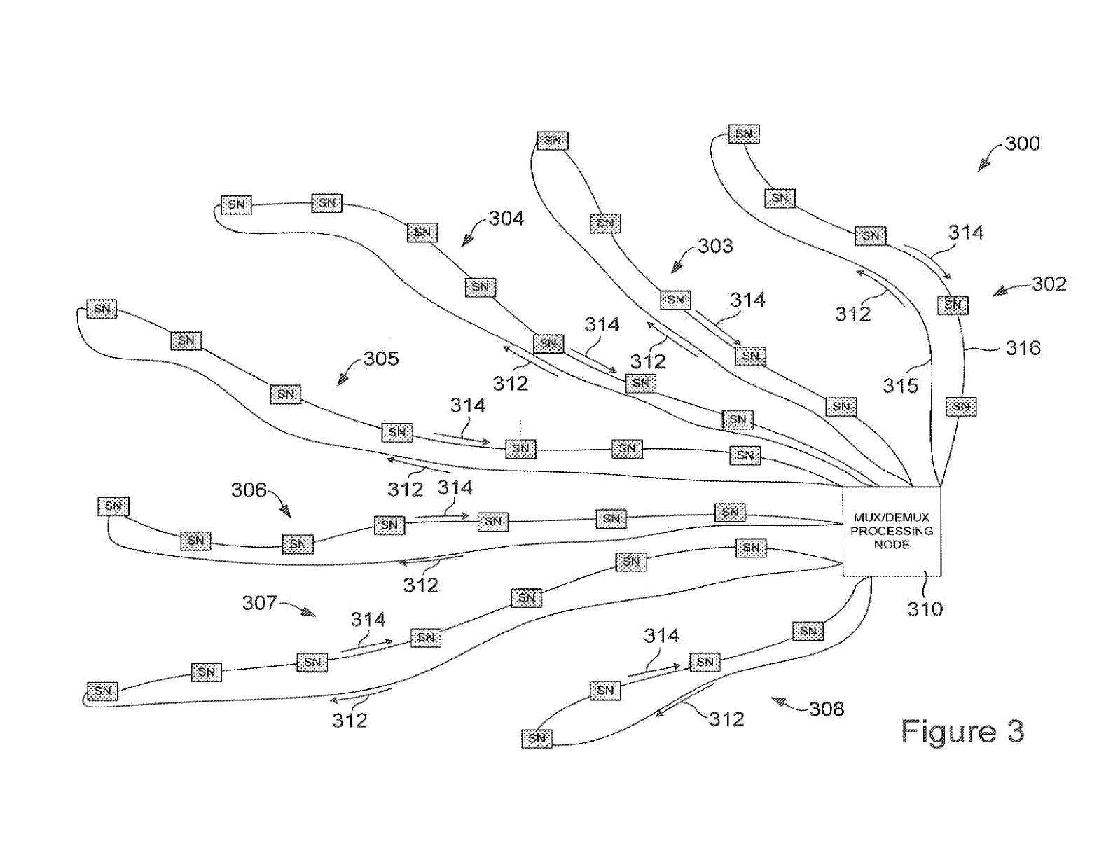

FIG. 3 shows a schematic representation of an example optical sensor network 300 configured in accordance with one or more embodiments of the present invention. The sensor network 300 also includes seven sensor lines 302-308 optically coupled to the processing node 310. The processing node 310 includes a multiplexer/demultiplexer (“MUX/DEMUX”) and a light source. The demultiplexer (not shown) of the processing node 310 places unmodulated wavelengths of light output from the light source into the output waveguides of the sensors lines 302-308, identified by outward directional arrows 312, so that out going unmodulated wavelengths travel past each sensor node unperturbed. Each sensor line includes input waveguides, identified by inward directional arrows 314, so that the corresponding sensor nodes can encode measurement results as the wavelengths return to the processing node 310. For example, sensor line 302 includes one or more waveguides 315 for carrying one or more unmodulated wavelengths output from a light source of the processing node 310 and one or more waveguides 316 for carrying the same wavelengths encoded with measurement results obtained by the sensor nodes to the processing node 310.

For the sake of simplicity, the example networks 100, 200, 300 have seven sensor lines with from 3 to 7 sensor nodes. However, embodiments of the present invention are not intended to be so limited. In other optical sensor network embodiments, the number of sensors lines can vary from as few as one sensor line to thousands of sensor lines, and each sensor line can be configured with tens, hundreds, and thousands of sensor nodes and extend for up to hundreds of kilometers.

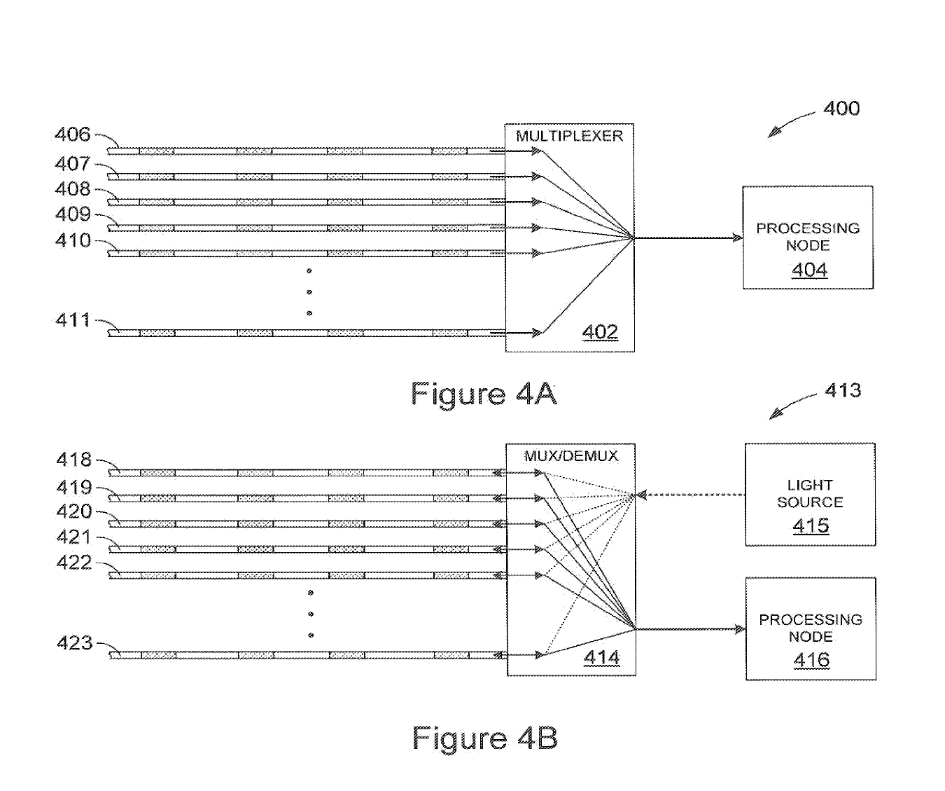

FIG. 4A shows a schematic representation of a multiplexer/processing node 400 configured in accordance with one or more embodiments of the present invention. The multiplexer/processing node 110 includes an optical multiplexer 402 and a processing node 404. The multiplexer 402 is coupled to n separate sensor lines, a few of which are represented by sensor lines 406-411, each sensor line including a number of sensor nodes 412. In the example of FIG. 4A, each sensor line transmits measurement results encoded in one or more wavelengths to the multiplexer 402. The wavelengths can be generated by light sources located at the ends of the sensor lines, as described above with reference to FIG. 1, or the wavelengths can be generated by each sensor node, as described above with reference to FIG. 2. The multiplexer 402 can be any wed-known device for performing multiple wavelength division multiplexing of the wavelengths into a single optical fiber 406, where the wavelengths, are transmitted to the processing node 404 for data processing.

FIG. 48 shows a schematic representation of a MUX/DEMUX processing node 413 configured in accordance with one or more embodiments of the present invention. The processing node 413 includes an optical MUX/DEMUX 414, light source 415, and a processing node 416. The MUX/DEMUX 414 is coupled to n separate sensor lines, a few of which are represented by sensor lines 418-423, each sensor line including a number of sensor nodes 412. In the example of FIG. 4B, the light source 415 generates different wavelengths that are injected into the MUX/DEMUX 414, which demultiplexes the wavelengths so that each sensor line carries one or more of the wavelengths. Each sensor line can be configured, as described above with reference to FIG. 3, so that the one or more wavelengths are sent out unperturbed past each sensor node and are modulated, by each sensor node as the wavelengths return to the MUX/DEMUX 414. The returning wavelengths encoded with measurement results are wavelength division multiplexed by the MUX/DEMUX 414 and sent to the processing node 416 for processing.

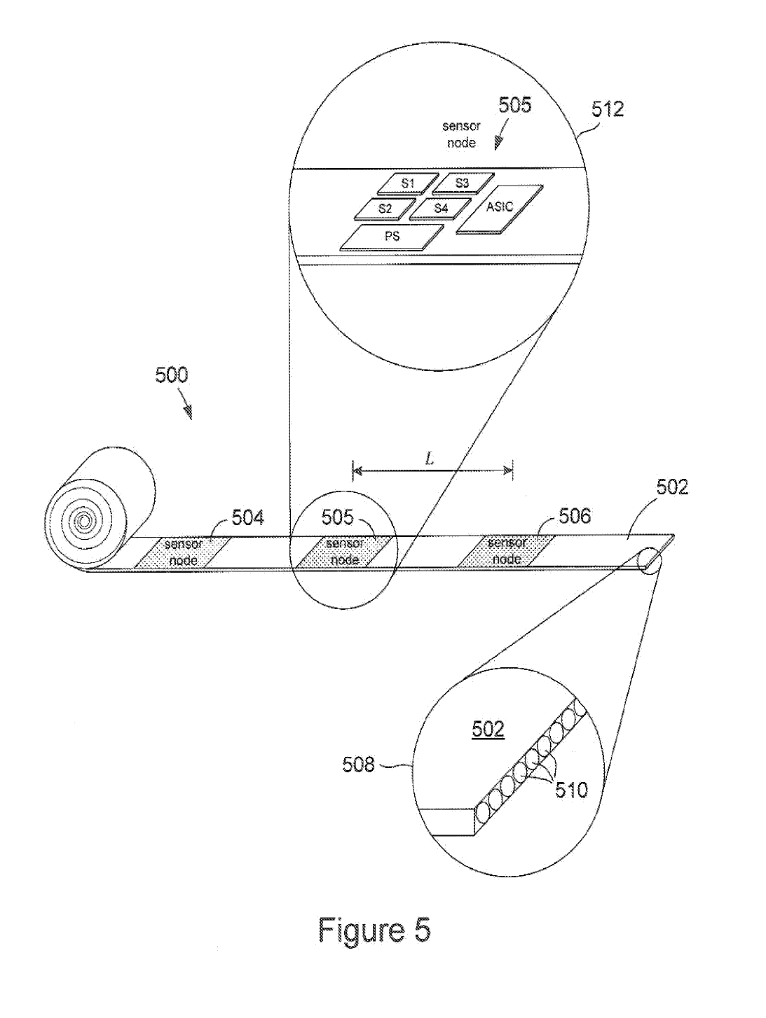

In certain embodiments, a waveguide of a sensor fine can be a multi-core, optical fiber ribbon, and the sensor nodes of the sensor line are integrated, or imprinted, on the ribbon. In other words, the ribbon serves as a substrate upon which the sensor node components can be directly integrated with the multiple cores comprising the ribbon. FIG. 5 shows an isometric view of a partially rolled-up sensor line 500 configured in accordance with one or more embodiments of the present invention. The sensor line 500 includes an optical fiber ribbon 502 integrated with sensors nodes 504-506 regularly, or irregularly, spaced along the length of the ribbon 502. The sensor nodes are separated by a distance, L, that can range horn a few tenths of a meter to loner distances such as tens, hundreds, and even thousands of meters. FIG. 5 includes an enlargement 508 revealing the fiber ribbon 502 is composed of multiple single mode, or multimode, optical fibers 510. FIG. 5 also includes an enlargement 512 of a sensor node 505. Enlargement 512 reveals an example arrangement of sensor node components. Sensor node 505 includes tow sensors, S1, S2, S3, and S4; a power source, PS; and an application-specific integrated circuit (“ASIC”). The ASIC controls the operation of each of the sensors. The same arrangement of sensor power source, and ASIC can be repeated for each sensor node located along the sensor line 500. Each sensor can be configured to measure temperature, vibration, humidity, and detect the presence of certain chemicals. In other embodiments, the power source can be integrated with the ASIC.

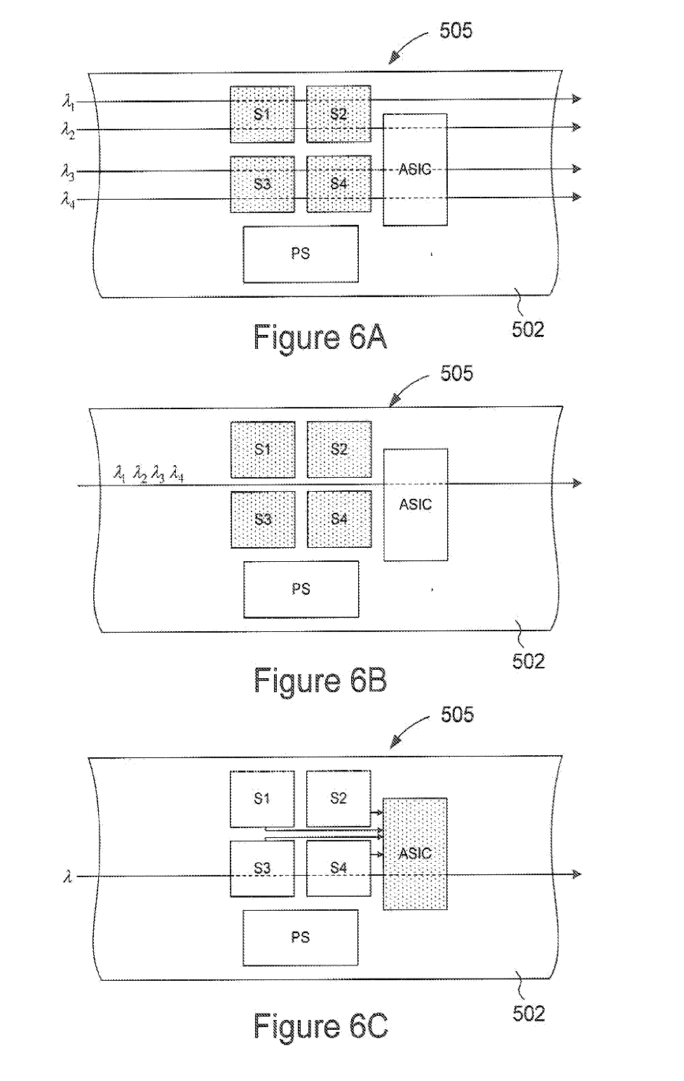

Embodiments of the present invention include a number of different, ways in which a sensor node can be configured and operated to encode measurement results in one or more wavelengths of light. FIGS. 6A-6C show top plan views of three different ways in which the sensor node 505 can be operated to encode measurement results in accordance with one or more embodiments of the present invention. In FIGS. 6A-6C, the wavelengths can be generated at an optical source located at the end of the optical fiber ribbon, as described above with reference to FIGS. 1 and 3. In FIG. 6A, the sensors S1, S2, S3, and S4, encode measurement results directly into different associated wavelengths λ₁, λ₂, λ₃, and λ₄, each wavelength carried by a separate optical fiber of the ribbon 502. In FIG. 6B, the sensors S1, S2, S3, and S4 encode measurement results directly into different associated wavelengths λ₁, λ₂, λ₃, and λ₄, respectively, all of which are carried by the same multimode optical fiber of the ribbon 502. In FIG. 6C, the sensors S1, S2, 53, and 54 send measurement results in the form of electrical signals to the ASIC, which encodes the measurement results in a single wavelength λ, or multiple wavelengths, carried by one optical fiber of the ribbon 502.

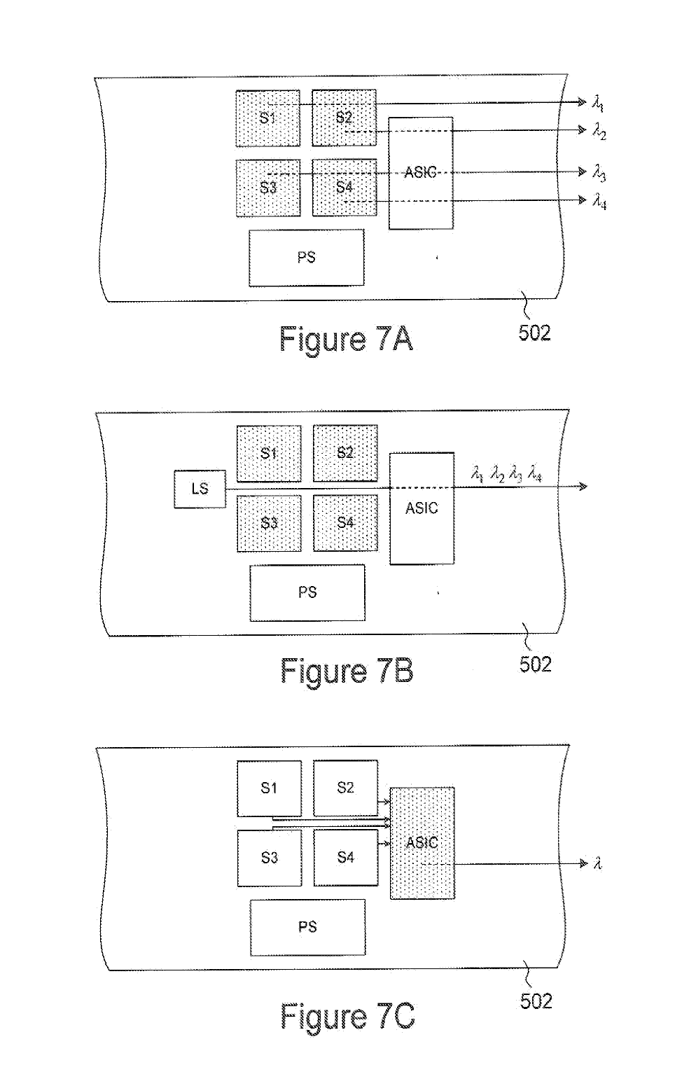

FIGS. 7A-7C show to plan views of three different ways in which the sensor node 505 can be operated to encode measurement results in locally generated wavelengths in accordance with one or more embodiments of the present invention. In FIGS. 7A-7C, the wavelengths for transmitting measurement results can be generated at each sensor node as described above with reference to FIG. 2. In FIG. 7A, the sensors S1, S2, S3, and S4 are each configured with a light source to generate one of the wavelengths λ₁, λ₂, λ₃, and λ₄. Each wavelength is injected into a separate optical fiber of the ribbon 502 and modulated by the corresponding sensor nodes S1, S2, S3, and S4 to encode measurement, results. In FIG. 7B, the sensor node 505 includes a separate light source that injects the wavelengths λ₁, λ₂, λ₃, and λ₄ in one multimode fiber of the ribbon 502. The sensors S1, S2, S3, and S4 encode measurement results by modulating each of the wavelengths λ₁, λ₂, λ₃, and λ₄, and respectively. In FIG. 7C, the ASIC, or a separate light source, is configured to generate and inject a wavelength λ into an optical fiber of the ribbon 502. The sensors S1, S2, S3, and S4 send measurement results in the form of electrical signals to the ASIC, which encodes the measurement results in the wavelength λ. The light sources described above can be LEDs, single mode or multimode semiconductor lasers, such as semiconductor edge-emitting lasers or vertical-cavity surface-emitting lasers, depending on how the light source is oriented for injecting light into the optical fibers.

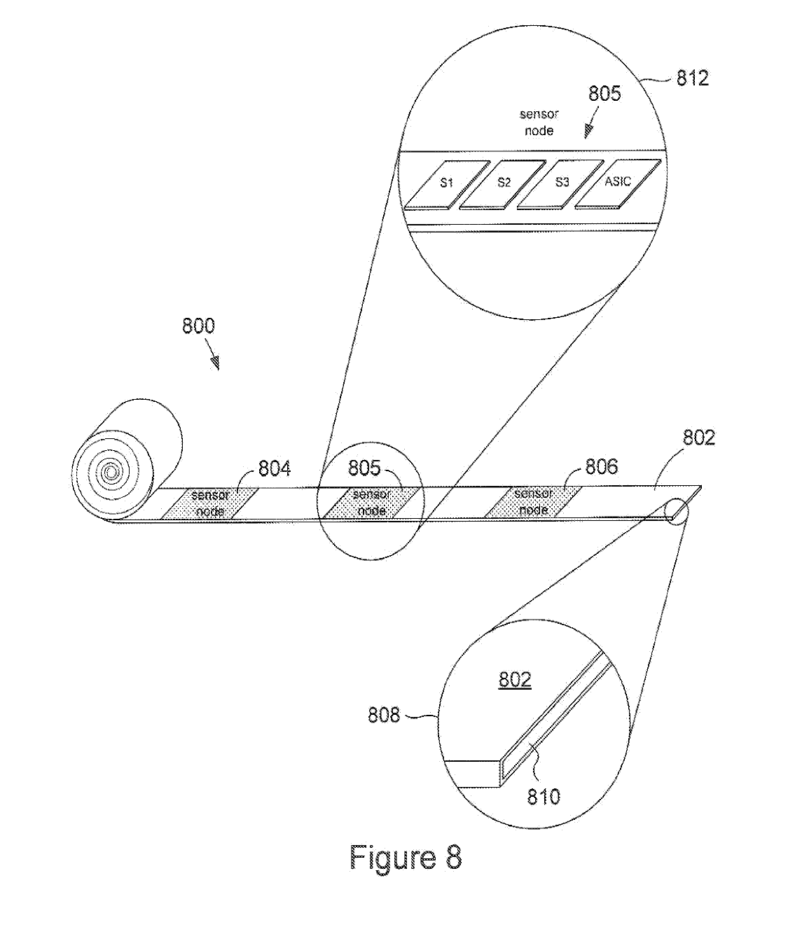

Embodiments of the present invention are not limited to multi-core, optical fiber ribbons. Sensor line embodiments include flat, single-core, optical ribbons that serve as a substrate upon which components of sensor nodes can be integrated and imprinted. FIG. 8 shows an isometric view of a partially rolled-up sensor line 800 configured in accordance with one or more embodiments of the present invention. The sensor line 800 includes a flat, single-core, optical ribbon 802 integrated with sensors nodes 804-806 distributed along the length of the ribbon 802. The number and spacing of sensor nodes distributed along the length of sensor line 800 is analogous to the number and spacing described above for sensor line 500. FIG. 8 includes an enlargement 508 revealing the single-core 810 with a rectangular cross-section of the ribbon 802. FIG. 8 also includes an, enlargement 812 of sensor node 805. Enlargement 812 reveals another example linear arrangement of sensor node components distributed along the ribbon 802. In this arrangement, the power source is integrated within the ASIC.

In certain embodiments, the ribbon 802 can be optically coupled to a light source and each sensor node can encode measurement results in wavelengths transmitted in the ribbon 802, as described above with reference to FIG. 6. In other embodiments, each sensor node can be configured with one or more light sources and either the sensors or the ASIC can be operated to encode measurement results in the locally generated wavelengths, as described above with reference to FIG. 7.

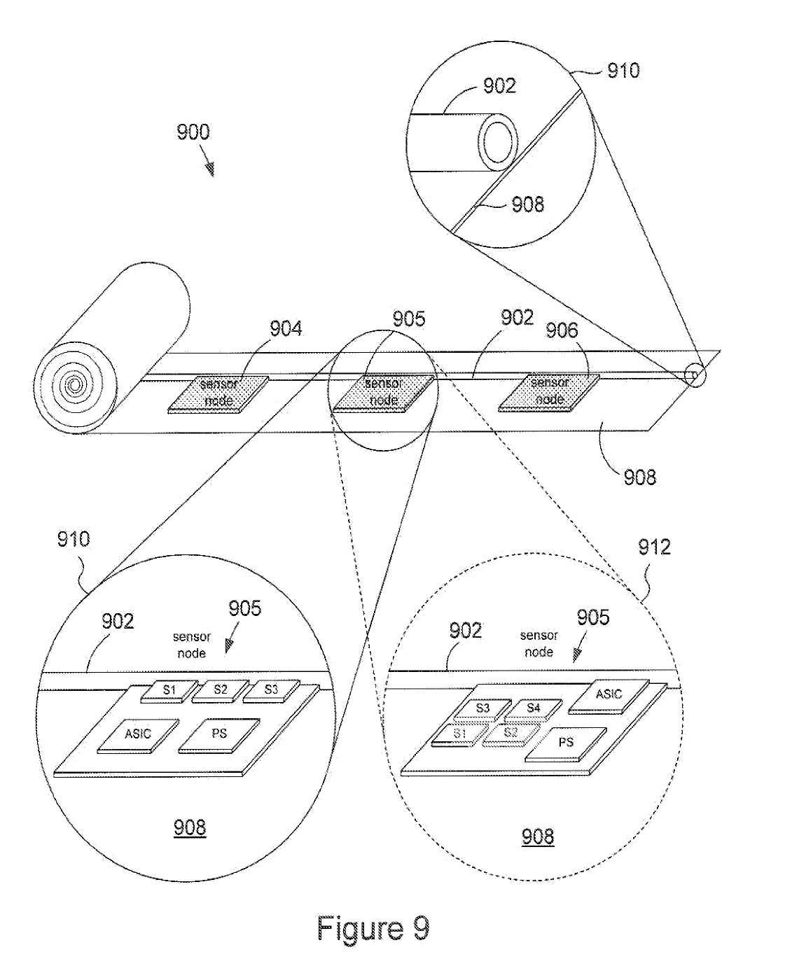

In the embodiments described above, the ribbons 402 and 702 serve as substrates for the various components of each sensor node. Embodiments of the present invention are so not limited. Sensor line embodiments can also be implemented using a multimode waveguide formed on a flexible substrate. FIG. 9 shows an isometric view of a partially rolled-up sensor line 900 configured in accordance with one or more embodiments of the present invention. The sensor line 900 includes a waveguide 902 integrated with sensors nodes 904-906 distributed along the length of the waveguide 902. As shown in the example of FIG. 9, the waveguide 902 and sensor nodes 904-906 are disposed on and supported by, a thin flexible substrate 908. In certain embodiments, the waveguide 902 can be a single mode ridge waveguide or a multimode ridge waveguide deposited on the substrate. In certain embodiments, the waveguide can be a single mode or multimode optical fiber. In other embodiments, as shown in enlargement 910, the waveguide can be a single mode or multimode hollow metal or plastic waveguide. FIG. 9 also includes two example arrangements of sensor node components shown in enlargements 910 and 912, in enlargement 910, the sensors S1, S2, and S3 are located adjacent to the waveguide 902 and are configured to modulate, or inject modulated, wavelengths carried by the waveguide 902. In enlargement 912, the ASIC is located adjacent to the waveguide 902 and is configured to modulate, or inject modulated, wavelengths carried by the waveguide 902.

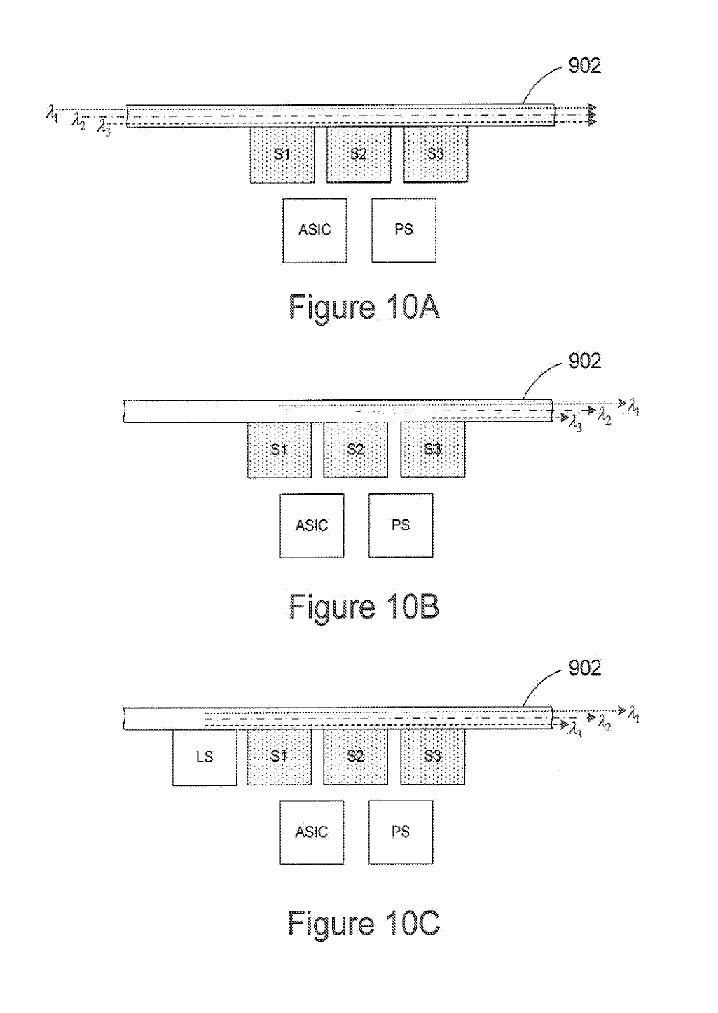

FIGS. 10A-10C show top plan views of three different ways in, which the sensor node 90 represented in enlargement 910 can be operated to encode measurement results in accordance with one or more embodiments of the present invention. In FIG. 10A, the sensors S1, S2, and S3 encode measurement results directly into different associated wavelengths λ₁, λ₂, and λ₃ carried by the waveguide 902. The wavelengths λ₁, λ₂, and λ₃ can be generated by a light source (not shown) located at the end of the waveguide 902 as described above with reference to FIGS. 1 and 3. In FIG. 10B, the sensors S1, S2, and S3 generate wavelength λ₁, λ₂, and λ₃, respectively, and encode measurement results directly into the associated wavelengths, all of which are injected into the waveguide 902, as described above with reference to FIG. 2. In FIG. 10C, the sensor node 905 includes, a light source that generates wavelengths λ₁, λ₂, and λ₃ and injects the wavelengths into the waveguide 902. The sensors S1, S2, and S3 separately modulate and encode measurement results in the wavelengths λ₁, λ₂, and λ₃, respectively.

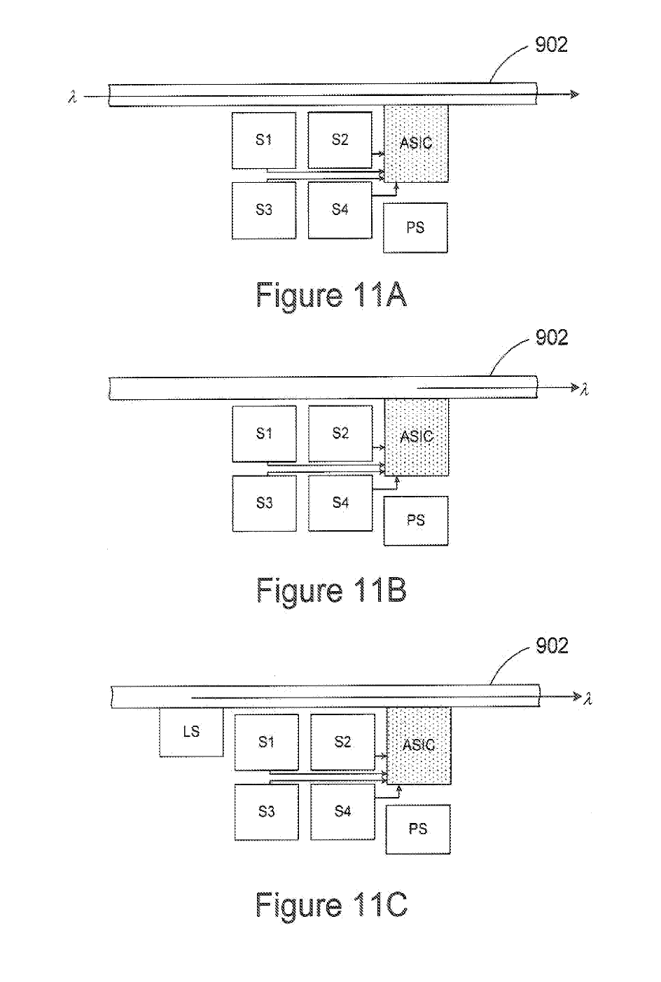

FIGS. 11A-11C show top plan views of three different ways in which the sensor node 905 represented in enlargement 912 can be operated to encode measurement results in accordance with one or more embodiments of the present invention. In FIG. 11A, a wavelength λ is generated by a light source (not shown) located at the end of the waveguide 902, as described above with reference to FIGS. 1 and 3. The sensors S1, S2, S3, and S4 send measurement results in the form of electrical signals to the ASIC. In FIG. 11B, the ASIC includes a light source that generates the wavelength locally. The ASIC modulates the wavelength to encode the measurement results supplied by the sensors and injects the wavelength into the waveguide 902. In FIG. 11C, the sensor node 905 includes a separate light source, LS, that injects an unmodulated wavelength λ into the waveguide 902. The ASIC then modulates the wavelength to encode the measurement results supplied by the sensors.

Note that sensor node configurations and operations described above with reference to FIGS. 6, 7, 10, and 11 are not intended to be exhaustive of the various ways sensor node components can be arranged or in which wavelengths can be modulated to encode measurement results obtained at the sensor nodes.

System embodiments of the present invention can employ wavelength selective elements (“WSEs”) that are electronically coupled to the sensor node components in order to modulate the light generated by a light source at the end of a waveguide or generated by a local light source. Waveguides confine light traveling unidirectionally with negligible loss, and multiple wavelengths can use the same waveguide with no interference. A WSE can be configured with a resonance wavelength substantially matching a particular wavelength of light carried by a waveguide so that by placing the WSE adjacent to and within the evanescent field of light traveling in, the waveguide, the WSE evanescently couples the wavelength of light from the waveguide and traps the light for a period of time. The resonance wavelength of a WSE can be electronically switched in and out of resonance with a wavelength of light carried by an adjacent waveguide by a sensor node component electronically coupled to the WSE. As a result, the WSE to be operated to modulate a wavelength of light travelling in the adjacent waveguide in order to encode measurement results. The WSE can also be operated to divert, or inject, the light from one waveguide, or a light source, into another waveguide.

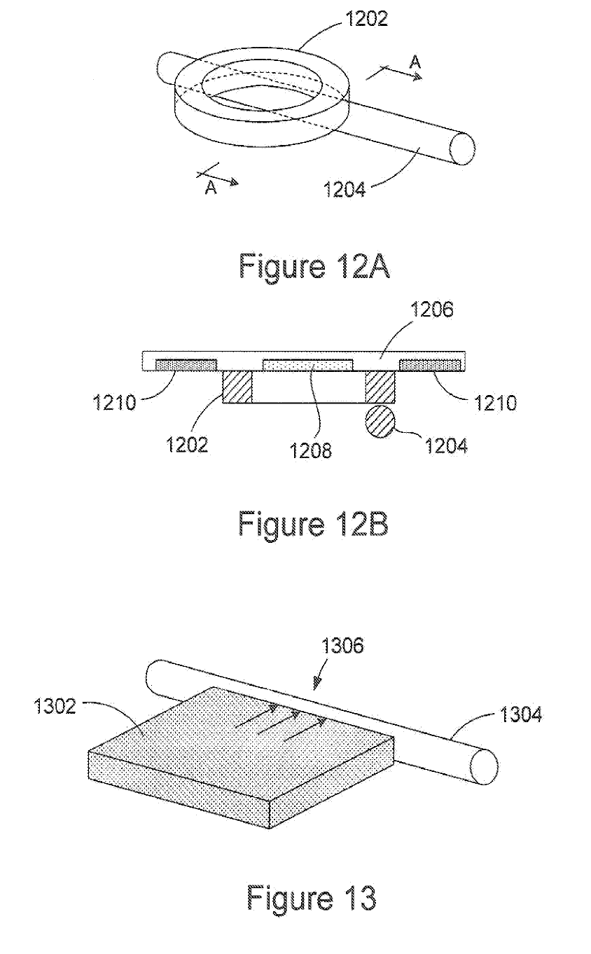

In certain embodiments, the WSE can be a microring resonator. FIG. 12A shows an isometric view and enlargement of a microring resonator 1202 and a portion of an adjacent waveguide 1204 in accordance with one or more embodiments of the present invention. The waveguide can be a single mode or multimode optical fiber, a hollow waveguide, or a ridge waveguide and can also be disposed adjacent to the outer edge of the microring 1202. Light of a particular wavelength transmitted along the waveguide 1204 is evanescently coupled from the waveguide 1204 into the microring 1202 when the wavelength of the light and the dimensions of the microring 1202 satisfy the resonance condition:

$$\frac{{L}_{p}}{m} = \frac{λ}{{n}_{eff} ( λ , T )}$$

where n_{eff} is the effective refractive index of the microring 1202, Lₚ is the effective optical path length of the microring 1202, m is an integer indicating the order of the resonance, and λ is the free-space wavelength of the light traveling in the waveguide 1204. The resonance condition can also be rewritten as λ=Lₚn_{eff}(λ,T)/m. In other words, the resonance wavelength for a resonator is a function of the resonator effective refractive index and optical path length.

Evanescent coupling is the process by which evanescent waves of light are transmitted from one medium, such as a microring, to another medium, such a ridge waveguide or optical fiber, and vice versa. For example, evanescent coupling between the microring 1202 and the waveguide 1204 occurs when the evanescent field generated by light propagating in the waveguide 1204 couples into the microring 1202. Assuming the microring 1202 is configured to support the modes of the evanescent field, the evanescent field gives rise to light that propagates in the microring 1202, thereby evanescently coupling the light from the waveguide 1204 into the microring 1202.

In other embodiments, the microring 1202 can be electronically tuned by doping regions of the substrate surrounding the microring 1202 with appropriate electron donor and electron acceptor impurities. FIG. 12B shows a cross-sectional view of the doped regions surrounding the microring 1202 along a ling A-A, shown in FIG. 12A, in accordance with one or more embodiments of the present invention. In certain embodiments, the microring 1202 and substrate 1206 comprises an intrinsic semiconductor material, an n-type region 1208 can be formed in the semiconductor substrate interior of the microring 1202, and a p-type region 1210 can be formed in the substrate 1206 surrounding the outside of the microring 1202. The microring 1202, the p-type region 1210, and the n-type region 1208 form a p-i-n junction. In other embodiments, the p-type and n-type impurities of the resonators can be reversed.

When electrical contact is made to the p-type region 1210 and the n-type region 1208, the resulting p-i-n junction may then be operated in forward- or reverse-bias mode. Under a forward bias, a change in the index of refraction of the microring 1202 may be induced through current injection. Under reverse bias, a high electrical field can be formed across the microring 1202 and a refractive index change can result through the electro-optic effect. Both of these electronic tuning techniques provide only a relatively small shift in the effective refractive index of the microring 1202, thereby changing the resonance wavelength of the microring.

The microring 1202 and the waveguide 1204 can be composed of an elemental semiconductor, such as silicon (“Si”) and germanium (“Ge”) or a compound semiconductor. Compound semiconductors can be composed of column IIIa elements, such as aluminum (“Al”), gallium (“Ga”), and indium (“In”), in combination with column Va elements, such as nitrogen (“N”)phosphorus (“P”), arsenic (“As”), and antimony (“Sb”). Compound semiconductors can also be further classified according to the relative quantities of III and V elements. For example, binary semiconductor compounds include semiconductors with empirical formulas GaAs, InP, InAs, and GaP; ternary compound semiconductors include semiconductors with empirical formula GaAs_{y}P_{1-y}, where y ranges from greater than 0 to less than 1; and quaternary compound semiconductors include semiconductors with empirical formula InₓGa₁₋ₓAs_{y}P_{1-y}, where both x and y independently range from greater than 0 to less than 1. Other types of suitable compound semiconductors include II-VI materials, where II and VI represent elements in the IIb and VIa columns of the periodic table. For example, CdSe, ZnSe, ZnS, and ZnO are empirical formulas of exemplary binary II-VI compound semiconductors.

P-type impurities can be atoms that introduce vacant electronic energy levels called “holes” to the electronic band gaps of the microring 1202. These impurities are also called “electron acceptors.” N-type impurities can be atoms that introduce filled electronic energy levels to the electronic band gap of the microring 1202. These impurities are called “electron donors,” For example, boron (“B”). Al, and Ga are p-type impurities that introduce vacant electronic energy levels near the valence band of Si; and P, As, and Sb are n-type impurities that introduce filled electronic energy levels near the conduction band of Si. In III-V compound semiconductors, column VI impurities substitute for column V sites in the III-V lattice and serve as n-type impurities, and column II impurities substitute for column III atoms in the III-V lattice to form p-type impurities. Moderate doping corresponds to impurity concentrations in excess of about 10¹⁵ impurities/cm³, while heavy doping corresponds to impurity concentrations in excess of about 10¹⁹ impurities/cm³.

In other embodiments, measurement results can be encoded in a wavelength by striking, or applying pressure to, the waveguide carrying the wavelength. FIG. 13 shows an isometric view of an example sensor node component 1302 operated in accordance with one or more embodiments of the present invention. The component 1302 is located in contact with a waveguide 1304. The component 1302 can represent a sensor or an ASIC. The waveguide 1304 can be an optical fiber, optical fiber of an optical fiber ribbon, a ridge waveguide, or a hollow waveguide. Suppose, for the sake of convenience, the component 1302 represents sensor, such as a temperature or humidity sensor. The component 1302 can be composed of materials that undergo different physical changes in shape as a result of a temperature or humidity change. The component 1302 can be configured so that these physical changes result in pressure applied to the adjacent waveguide 1304, as indicated by directional arrows 1306. The applied pressure can cause a shape change in the cross-sectional dimensions of the optical fiber 1304 thereby affecting the intensity of the wavelength transmitted in the waveguide 1304. Now suppose the component 1302 represents an ASIC. The component 1302 can include a micro-electro-mechanical system that the component 1302 operates to apply pressure to, or strike, the waveguide 1304 in response to the electrical signals received from one or more electronically coupled sensors. In other embodiments, the component 1302 can be configured to inject current in the waveguide 1304 in order to change the refractive index of the waveguide 1304.

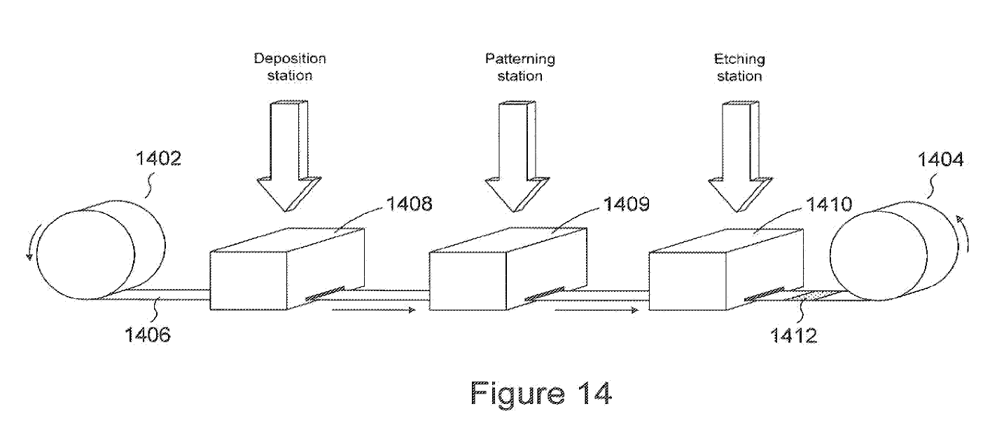

FIG. 14 shows a roll-to-roll process for imprinting sensor nodes on a sensor line in accordance with one or more embodiments of the present invention, the process of imprinting sensor node components on the ribbon 1406 can be performed in a continuous assembly-line-like process to produce a finished roll of sensor nodes 1404 for use in a sensor network. FIG. 14 shows an unprinted first portion 1402 and a finished printed second portion 1404 wound into rots at opposite ends of a flat ribbon of material 1406. The ribbon can be a multi-core, optical fiber ribbon 502 described above with reference to FIG. 5; a flat, single-core optical ribbon 802 described above with reference to FIG. 8; or a flexible material or substrate 908 described above with reference to FIG. 9. The ribbon 1406 is fed through stations 1408-1410, each station operated to perform a step or series of steps in obtaining sensor nodes 1412 imprinted on the surface of the ribbon and rolled into finished roll 1404. In the example shown in FIG. 14, a first station 1408 performs chemical vapor deposition of various material layers, including chemical vapor deposition (“CVD”), plasma-enhanced CVD (“PECVD”), metalorganic CVD (“MOCVD”), or aerosol assisted CVD (“AACVD”) just to name a few of the techniques for deposition various semiconductor, metal, and dielectric material layers. After certain layers have been deposited in the deposition station 1408, the ribbon 1406 then passes through the patterning station where the deposited materials are patterned into various microelectronic devices, such as, but not limited to, diodes, photodiodes, transistors, field-effect sensors, capacitors, memristors, and other kinds of circuit and sensor elements, using various lithographic techniques including nanoimprint lithogaphy, photolithograhy, or electron beam lithography just to name a few. The ribbon then passes through etching station 1410 where excess deposited materials can be removed. For example, the etching station 1410 can be configured to perform reactive-ion etching. A finished sensor node 1412 emerges from the etching station and is rolled into finished roll 1404.

Note that method for fabricating sensor lines in a roll-to-roll process is not limited to the three stations described above with reference to FIG. 14. For the sake of simplicity and convenience, only three processing stations are represented. In practice, the number of processing stations involved in imprinting the various sensor node components on a ribbon can vary. For example, depending on the kinds of components to be formed, a number of deposition, patterning, and etching stations arranged to deposit and pattern particular layers of materials can be placed at various points along an assembly line for forming sensor nodes.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes at illustration and description. They are not intended to be exhaustive of or to limit the invention to, the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A sensor network comprising:
a processing node (110, 310); and
one or more sensor lines (102,202,302) optically coupled to the processing node, each sensor line comprising:
a waveguide (116216,316), and
one or more sensor nodes (112,210), each sensor node optically coupled to the waveguide and configured to measure one or more physical conditions and encode measurement results in one or more wavelengths of light carried by the waveguide to the processing node.

2. The sensor network of claim 1, further comprising a multiplexer (402) optically coupled to each of the one or more sensor lines and configured to receive the one or more wavelengths with encoded measurement results from each of the sensor lines and route the wavelengths to the processor node.

3. The sensor network of claim 1, wherein each sensor line further comprises a light source (118) disposed at the end of the waveguide, the light source configured to generate and inject the one or more wavelengths of light used by the one or more sensor nodes to encode the measurement results.

4. The sensor network of claim 1, wherein each of the one or more sensor nodes further comprises one or more light sources configured to generate the one or more wavelengths of used by the sensor node to encode measurement results.

5. The sensor network of claim 1, further comprising:
a multiplexer/demultiplexer (414) optically coupled to the processing node and the one or more sensor lines; and
a light source (415) optically coupled to the multiplexer/demultiplexer and configured to generate the one or more wavelengths of light, wherein the multiplexer/demultiplexer receives and injects the one or more wavelengths into the waveguides of the one or more sensor nodes and receives the one or more wavelengths with encoded measurement results from each of the sensor lines and routes the wavelengths to the processor node

6. The sensor node of claim 1, wherein the waveguide further comprises a multi-core, optical fiber ribbon (502) and components of the one or more sensor nodes are imprinted on the ribbon.

7. The sensor node of claim 1, wherein the waveguide further comprises a flat, single-core, optical ribbon (802) and components of the one or more sensor nodes are imprinted on the ribbon.

8. The sensor node of claim 1, wherein the sensor line further comprises a flexible substrate (908) upon which the waveguide and the one or more sensor nodes are disposed.

9. The sensor node of claim 8, wherein the waveguide further comprises one of:
a hollow waveguide (902); and
an optical fiber.

10. The sensor network of claim 1, wherein each sensor node further comprises:
one or more sensors and
an application-specific integrated circuit electronically coupled to, and configured to control the operation of, the one or more sensors, wherein measurement results obtained from the one or more sensors are encoded in the one or more wavelengths of light in the one or more waveguides optically coupled to the sensor node.

11. The sensor network of claim 11, wherein the one or more sensors are optically coupled to the waveguide and configured to encode measurement results in the one or more wavelengths.

12. The sensor network of claim 11, wherein the application-specific integrated circuit is optically coupled to the waveguide, receives measurement results encoded in electronic, signals from the sensors, and encodes the measurement results in the one or more wavelengths.

13. A method for fabricating a sensor network comprising:
unrolling a single ribbon substrate (1402), the ribbon including one or more waveguides;
depositing (1408) one or more materials layers on portions of the ribbon;
patterning (1409) one or more sensor node microelectronic components in the material layers; and
etching (1410) the sensor node components to remove excess material.

14. The method of claim 13, wherein the ribbon material further comprises at least one of:
a multi-core, optical fiber ribbon (502); and
a flat, single-core optical ribbon (802).
